(19) United States
(12) Patent Application Publication
(10) Pub. No.: US 2016/0125541 A1
(43) Pub. Date: May 5, 2016

(54) METHOD, SYSTEM AND COMPUTER PROGRAM PRODUCT FOR ASSET ALLOCATION AND WITHDRAWAL

(71) Applicant: Raymond John Gianantoni, Springfield, MA (US)

(72) Inventor: Raymond John Gianantoni, Springfield, MA (US)

(21) Appl. No.: 14/931,493

(22) Filed: Nov. 3, 2015

Related U.S. Application Data
(60) Provisional application No. 62/074,154, filed on Nov. 3, 2014.

(51) Int. Cl. G06Q 40/06

(52) U.S. Cl. CPC G06Q 40/06

(57) ABSTRACT

According to one embodiment, withdrawal parameters associated with a financial product are obtained via a user interface. The withdrawal parameters include a withdrawal period, an investment amount, a beginning year and a desired end balance. Historical rates of return associated with a plurality of asset classes for the withdrawal period are obtained. An optimal withdrawal amount for the beginning year is calculated based at least in part upon the withdrawal parameters and the historical rates of return, wherein the optimal withdrawal amount is withdrawn from an asset class having the highest rate of return in the beginning year. Optimal withdrawal amounts for subsequent years of the withdrawal period are calculated based at least in part upon the optimal withdrawal amount for the beginning year, wherein the optimal withdrawal amount for each subsequent year is withdrawn from an asset class having the highest rate of return in said subsequent year.

### CROSS-REFERENCE TO RELATED APPLICATION

This application is a non-provisional patent application that claims the benefit of provisional patent application Ser. No. 11/479,189 filed on Nov. 3, 2014, the entire disclosure of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates to the field of computerized methods and systems for financial planning, and more particularly, to computerized methods and systems for providing investment or retirement portfolio allocations and withdrawals among a plurality of financial investment vehicles.

### BACKGROUND

People plan for their retirement by investing in their financial assets in various financial products—i.e., investment vehicles, such as bonds, equities, international funds, etc., and make periodic withdrawals (for example, yearly) from these assets to fund their expenses during the retirement. Conventional retirement planning tools typically recommend investors to distribute their investments roughly equally into equities and bond. Also, as the investors grow older, these tools advise the investors to reduce exposure to equities and increase investments in safer options, such as, bonds, to reduce financial volatility. Equities performance data indicates, however, that the average yield for equities over last 30 years was about 12.7% as compared to an average yield of 7.6% for bonds. Thus, every dollar moved from equity asset accounts to bond accounts, using the aforementioned as an example, would have resulted in a loss of 40% to the investor. Further, the investors are recommended a strategy to withdraw funds from the investment at an average annual withdrawal rate of about 4% indexed to CPI-U. Based on such a strategy, however, the opportunity costs are typically high and can render the investments less productive. Research shows that such an investment strategy has only about 80% probability of funds lasting the full withdrawal period. So, eventually, the investors may run out of funds in their old age.

### SUMMARY

The present disclosure relates to a method and a computer program product for distributing financial assets amongst a plurality of financial products and calculating the optimal periodic withdrawal amount from one or more of the financial product accounts, i.e., asset or investment accounts. According to an embodiment, the method includes obtaining withdrawal parameters associated with the financial product (and investor) that are obtained from a user via a user interface. The withdrawal parameters include a withdrawal period, an investment amount, a beginning year and a desired end balance. The method further includes obtaining historical rates of return associated with a plurality of asset classes for the withdrawal period from a data storage unit. The method further includes calculating an optimal withdrawal amount for the beginning year based, at least in part, upon the withdrawal parameters and the historical rates of return, wherein the optimal withdrawal amount for the beginning year is withdrawn from an asset class from the plurality of asset classes having the highest rate of return in the beginning year. The method further includes calculating optimal withdrawal amounts for subsequent years of the withdrawal period based, at least in part, upon the optimal withdrawal amount for the beginning year, wherein the optimal withdrawal amount for each subsequent year is withdrawn from an asset class from the plurality of asset classes having the highest rate of return in said subsequent year.

According to a further embodiment, the computer program product includes a non-transitory computer readable storage medium, and a computer program code embedded in the non-transitory computer readable storage medium for causing a processor to obtain, from a user via a user interface, withdrawal parameters associated with a financial product, the withdrawal parameters comprising a withdrawal period, an investment amount, a beginning year and a desired end balance. The computer program code embedded in the non-transitory computer readable storage medium further causes the processor to obtain, from a data storage unit, historical rates of return associated with a plurality of asset classes for the withdrawal period. The computer program code embedded in the non-transitory computer readable storage medium further causes the processor to calculate an optimal withdrawal amount for the beginning year based at least in part upon the withdrawal parameters and the historical rates of return, wherein the optimal withdrawal amount for the beginning year is withdrawn from an asset class from the plurality of asset classes having the highest rate of return in the beginning year. The computer program code embedded in the non-transitory computer readable storage medium further causes the processor to calculate optimal withdrawal amounts for subsequent years of the withdrawal period based at least in part upon the optimal withdrawal amount for the beginning year, wherein the optimal withdrawal amount for each subsequent year is withdrawn from an asset class from the plurality of asset classes having the highest rate of return in said subsequent year.

According to an embodiment, the system includes a data storage unit to store historical rates of return for a plurality of asset classes and a processing unit, coupled to the data storage unit, configured to obtain, from a user via a user interface, withdrawal parameters associated with a financial product, the withdrawal parameters comprising a withdrawal period, an investment amount, a beginning year and a desired end balance. The processing unit is further configured to obtain, from the data storage unit, the historical rates of return associated with the plurality of asset classes for the withdrawal period. The processing unit is further configured to calculate an optimal withdrawal amount for the beginning year based at least in part upon the withdrawal parameters and the historical rates of return, wherein the optimal withdrawal amount for the beginning year is withdrawn from an asset class from the plurality of asset classes having the highest rate of return in the beginning year. The processing unit is further configured to calculate optimal withdrawal amounts for subsequent years of the withdrawal period based at least in part upon the optimal withdrawal amount for the beginning year, wherein the optimal withdrawal amount for each subsequent year is withdrawn from an asset class from the plurality of asset classes having the highest rate of return in said subsequent year.

The above summary does not include an exhaustive list of all aspects of the present invention or all embodiments of which the present invention may take. Indeed, the inventors contemplate that the invention includes all systems and methods that can be practiced from all suitable combinations of the various aspects and embodiment summarized above, as well as those disclosed in the detailed description below and particularly pointed out in the claims. Such combinations have particular advantages not specifically recited in the above summary. Similarly, these and other objects and advantages of the present invention will become apparent from the following detailed description when taken in conjunction with the accompanying drawings.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates an exemplary method for calculating optimal withdrawal amounts for a financial product, in accordance with an embodiment of the present disclosure.

FIG. 2 illustrates an exemplary method for calculating an optimal withdrawal amount in a beginning year, in accordance with an embodiment of the present disclosure.

FIG. 3(A) illustrates an exemplary user interface for receiving withdrawal parameters associated with a financial product, in accordance with an embodiment of the present disclosure.

FIG. 3(B) illustrates an exemplary user interface displaying yearly optimal withdrawal amounts from two asset classes for first 15 years of a withdrawal period, in accordance with an embodiment of the present disclosure.

FIG. 3(C) illustrates an exemplary user interface displaying yearly optimal withdrawal amounts from the two asset classes for subsequent first 15 years of the withdrawal period, in accordance with an embodiment of the present disclosure.

FIG. 3(D) illustrates an exemplary user interface displaying distribution of asset classes over the withdrawal period, in accordance with an embodiment of the present disclosure.

FIG. 4 illustrates an exemplary system for calculating optimal withdrawal amounts for a financial product, in accordance with an embodiment of the present disclosure.

While the present invention will be described and disclosed in connection with certain preferred embodiments, it is not intended to limit the invention to those specific embodiments. Rather, it is the applicant's intention to cover all such alternative embodiments and modifications as fall within the spirit and scope of the appended claims.

### DETAILED DESCRIPTION

The present disclosure provides a method, a system and a computer program product for calculating optimal withdrawal amounts for a financial product such as a retirement planning product. According to an embodiment, withdrawal parameters associated with the financial product are obtained. The withdrawal parameters may include a withdrawal period, an investment amount, a beginning year and a desired end balance. Historical rates of return data associated with multiple asset classes for the withdrawal period are obtained, from a database. An optimal withdrawal amount is calculated for the beginning year based upon the withdrawal parameters and the historical rates of return. The calculation of the optimal withdrawal amount for the beginning year may include an iterative process which may be repeated until the desired end balance is achieved. Optimal withdrawal amounts for subsequent years of the withdrawal period are calculated based upon the optimal withdrawal rate for the beginning year. The optimal withdrawal amount in each year of the withdrawal period is withdrawn from an asset class having the highest rate of return in that year.

The historical rates of return are utilized in the calculation to mirror potential rates of return during a withdrawal phase. Also, the method, system and computer program product preserve investments in a high yielding asset class (for example, an equity fund) during a bad year by withdrawing from another asset class (for example, a bond fund) having a higher rate of return in that year. This leads to higher total withdrawal amount when compared to conventional techniques that reduce the percentage of assets in equities irrespective of the rates of return. Further, the method, system and computer program product of the present disclosure allow the user to view the optimal withdrawal amount for different scenarios before actually making the investment. Thus, the method, system and computer program product of the present disclosure therefore provide a retirement planning technique that optimizes asset allocation and withdrawals for the user while allowing the user to maximize potential legacy and/or liquidity needs, and minimize the probability of depleting total assets prior to the end of the withdrawal period.

As will be appreciated by one skilled in the art, aspects of the present disclosure may be embodied as a method or a computer program product. Accordingly, aspects of the present disclosure may take the form of an entirely hardware based embodiment, an entirely software based embodiment (including firmware, resident software, micro-code, etc.) or an embodiment combining software and hardware features that generally may be referred to herein as a “system”, a “device”, or an “apparatus”. Furthermore, aspects of the present disclosure may take the form of a computer program product embodied in one or more non-transitory computer readable medium(s) having computer readable program code embodied thereon.

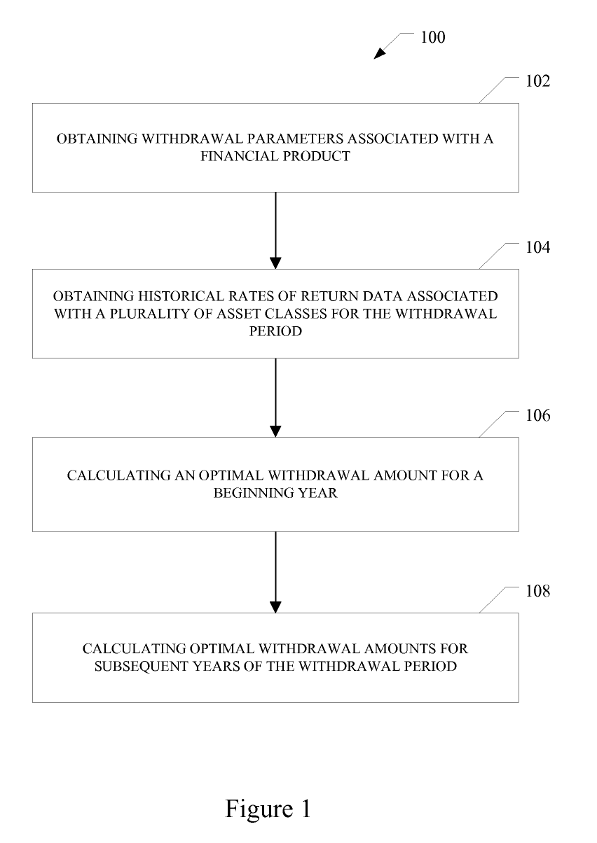

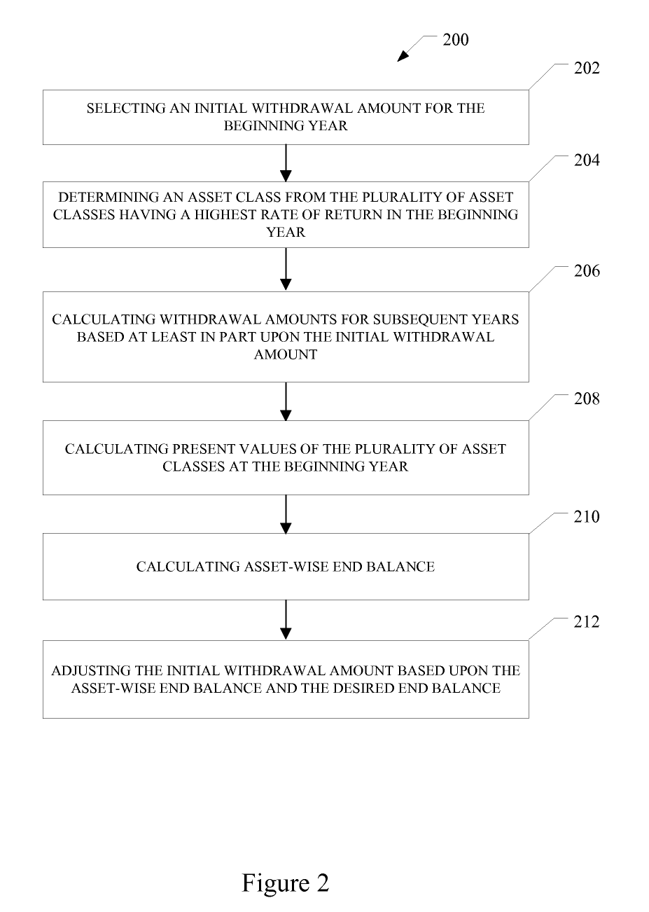

Methods 100 and 200 for calculating optimal withdrawal amount for a financial product are now described in detail with reference to the FIGS. 1-2. As such, the depicted order and labeled steps are indicative of one embodiment of the presented methods 100 and 200. Other steps and methods may be conceived that are equivalent in function, logic, or effect of one or more steps or portions thereof, of the illustrated methods 100 and 200. Additionally, the format and symbols employed are provided to explain the logical steps of the methods 100, and 200 and are understood not to limit the scope of the methods 100, and 200.

Referring now to the figures, FIG. 1 illustrates an exemplary method 100 for calculating optimal withdrawals for a financial product, in accordance with an embodiment of the present disclosure. In an embodiment, the financial product may be a retirement planning product. In another embodiment, the financial product may be an annuity-based product. The method 100 may be implemented using a computing system, hereinafter referred to as a “system”. At step 102, withdrawal parameters associated with the financial product are obtained from a user via a user interface. The user interface may be, for example, a Microsoft Excel spreadsheet, a graphical user interface presented by an application associated with the financial product, or a web-based interface accessible over a network. The withdrawal parameters may include a withdrawal period, an investment amount, a beginning year, and a desired end balance. The withdrawal period indicates a number of years withdrawals are to be made from investments in the financial product. The beginning balance indicates an amount of investment to be made in the financial product. The desired end balance indicates an amount that the user wants to retain in the investment upon completion of the withdrawal period. Example reasons, for a desired positive balance, may be that the user may wish to leave a bequest or that the user may want to hedge against investment uncertainties by retaining the amount. In this case, the user may input a desired amount as the desired end balance. The user may also choose to maintain a zero balance upon completion of withdrawal period, in which case, the user may enter zero as the desired end balance. The beginning year denotes a first year to mirror returns based upon historical data. The beginning year may be any year for which historical rate of return are available. The withdrawal parameters may further include a selection of an option by the user pertaining to whether or not withdrawal amounts are to be indexed using an indexing parameter, and whether a historical index is to be used as the indexing parameter. The user may also be able to provide a desired rate as the indexing parameter. The withdrawal parameter may also include an adjustment parameter. The adjustment parameter may be asset-class specific and denote an adjustment to be made in returns for the corresponding asset class to reflect loads, expenses, and/or performance adjustments. In an embodiment, the adjustment parameter is a value represented in terms of basis points. Withdrawal parameters may also include an age and a gender of the user. The system may automatically determine life expectancy based upon the gender. The withdrawal parameter may further include a start date denoting a date at which the withdrawals are supposed to start. The start date may be in the current year or may be in a future year. If the start date is in the future year, the system may consider the withdrawal parameters of the current year to calculate the optimal withdrawals, in accordance with an embodiment.

At step 104, historical rates of return associated with a plurality of asset classes for the withdrawal period are obtained from a data storage unit. The plurality of asset classes correspond to asset classes that the investor wishes to make investments in under the financial product. The plurality of asset classes include, for example, a bond fund, an equity fund, an international fund, an exchange traded fund, etc. The historical rates of return may be, for example, historical S&P 500 index values for the equity fund or historical Barclays aggregate bond index values for the bond fund and so on. The historical rates of return starting from the beginning year until the end of the withdrawal period are obtained. In an embodiment, when historical rates of return are not available for the complete withdrawal period, the historical rates of return for years prior to the beginning year are obtained to complete the historical rates of return for the entire withdrawal period. For example, when the beginning year is year 2000, the withdrawal period is 30 years and the historical rates of return are not available beyond the year 2014, the historical rates for 15 years prior to the year 2000 are obtained, i.e., the historical rates are considered from the year 2000 to the year 2014 and then from the year 1985 to the year 1999, thereby completing the withdrawal period. Thus, the historical rates of return are obtained in a circular manner if required. Further, the historical rates of return for the plurality of asset classes may be adjusted based upon the respective adjustment parameter. For example, if the user selects −5 basis points as the adjustment parameter for the equity account, the historical rates of return for the equity account are reduced by 5 basis points.

At step 106, an optimal withdrawal amount for the beginning year is calculated based at least in part upon the withdrawal parameters and the historical rates of return. The historical rates of return for the plurality of asset classes for the beginning year are compared and an asset class having the highest rate of return is determined. The optimal withdrawal amount for the beginning year is withdrawn from the determined asset class.

At step 108, a withdrawal amount for each subsequent year of the withdrawal period is calculated based at least in part upon the optimal withdrawal amount for the beginning year. In each subsequent year, the calculated withdrawal amount is withdrawn from an asset classes having the highest rate of return in that year. For example, if a first asset class has the highest rate of return amongst the plurality of asset classes in a given year, the withdrawal amount for the given year is withdrawn from the first asset class, whereas if a second asset class has the highest rate of return in another year, the withdrawal amount for that year is withdrawn from the second asset class.

In an embodiment, the withdrawal amounts for the subsequent years are indexed to the optimal withdrawal amount for the beginning year using the indexing parameter. For example, if a value of the indexing parameter for a second year of the withdrawal period is 3%, the withdrawal amount for the second year is equal to 1.03 times the optimal withdrawal amount for the beginning year. Further, if the value of the indexing parameter for a third year of the withdrawal period is 4%, the withdrawal amount for the third year is equal to 1.04 times the withdrawal amount for the second year and so forth. In an embodiment, the indexing parameter may be a consumer price index such as the consumer price index for urban consumers (CPI-U). The system may enable the user to make a selection of whether the withdrawal amounts are to be indexed to the consumer price index, or enter a desired value for the indexing parameter or choose not to index the withdrawal amount.

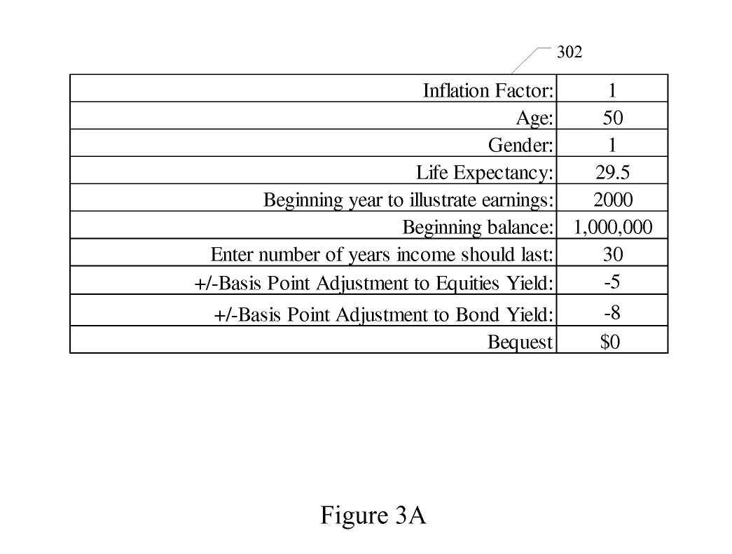

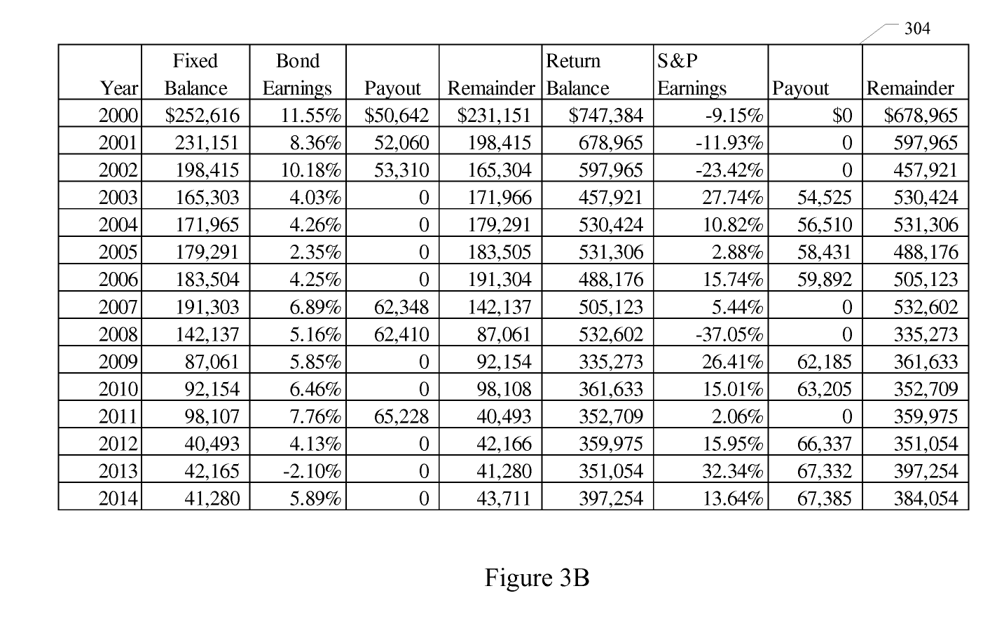

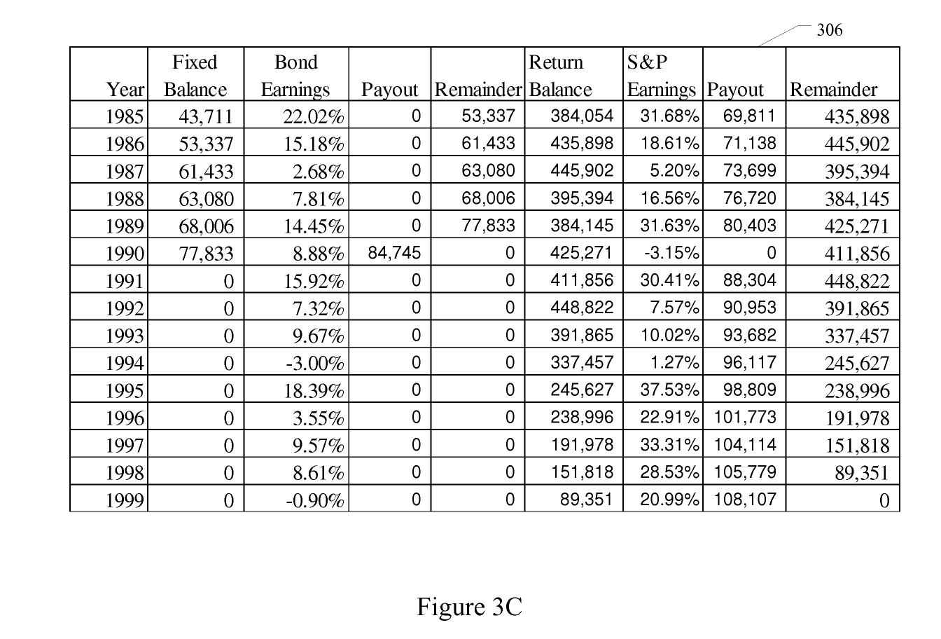

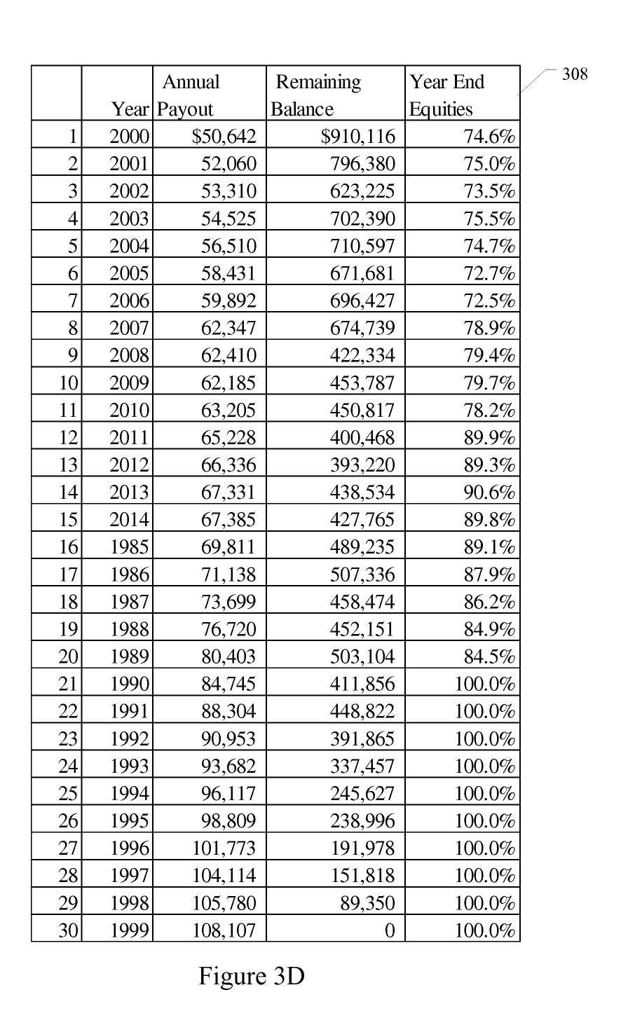

Upon calculating the optimal withdrawal amounts for the withdrawal period, present values of the plurality of asset classes at the beginning year are determined. Further, a percentage distribution of assets at the beginning year is calculated. In addition, for each year and for each asset class, a beginning balance and a remaining balance is calculated based upon the remaining balance for a preceding year, the withdrawal amount in the year and the historical rate of return for the year. A report may be presented to the user illustrating a withdrawal scenario calculated by the system. An example of such a report is illustrated in FIGS. 3(B)-3(D). Such a report helps the user to understand the optimal withdrawal amounts that are achievable given the investment amount and desired end balance when the rates of return for the plurality of asset classes mirror the historical rates of return starting from the chosen beginning year. Further, a simulation, for example, a Monte-Carlo simulation, is performed to determine a probability of success for a given withdrawal scenario. The user is able to select a different withdrawal scenario, for example, by selecting a different beginning year, a different desired end balance, a different investment amount, etc., and any combinations thereof. The system then calculates the optimal withdrawal amount for the different withdrawal scenarios and associated success probabilities, and presents a report of the calculation. Thus, the user is able to see potential optimal withdrawal amounts for different scenarios—for example, withdrawals beginning in the worst equity year, withdrawals beginning in the best equity year and so forth.

In conventional methods, asset allocation for the entire withdrawal period is substantially decided prior to the user chooses to invest and starts withdrawing funds upon retirement. In addition, the conventional method move investments from a potentially high yielding and high risk assets to potentially low yielding and low risk assets in order to guarantee payouts over the withdrawal period at a certain withdrawal rate. In contrast, the present disclosure proposes a computerized method that increases withdrawal amounts by optimizing asset allocation and withdrawal amounts at each year based upon historical performance of different asset classes (as demonstrated by the historical rates of return) as an approximation of future performance of the different asset classes. This increases the probability of success of achieving the optimized asset allocation and withdrawal amounts.

In an embodiment, the system is capable of comparing the end balance of the present disclosure with an end balance as determined by conventional techniques, such as, target date fund techniques, traditional investment techniques, etc. Similarly, the system allows comparison of the optimal withdrawal amount and the total withdrawal amount determined by the system with withdrawal amounts determined by the conventional techniques such as traditional modelling and target date modelling. The system provides results of the comparisons to the user. The user can then make a more informed decision about the investments in the financial product.

In an embodiment, the user may select the beginning year. In an embodiment, the system may automatically select the beginning year. In one exemplary implementation, the system may select a worst year in terms of returns for a certain asset class from the withdrawal period as the beginning year. The system selects the worst year as the beginning year to find a worst possible outcome of investing a certain amount of money for a particular withdrawal period or for minimizing the possibility of shortage of money. In another exemplary implementation, the system may select a best year in terms of returns for a certain asset class from the withdrawal period as the beginning year. This may be done, for example, to demonstrate a best case scenario of returns to the investor.

FIG. 2 illustrates an exemplary method 200 for calculating the optimal withdrawal amount for the beginning year, in accordance with an embodiment of the present disclosure. At step 202, an initial withdrawal amount for the beginning year is selected. The initial withdrawal amount may be entered by the user or may be determined automatically based upon a desired withdrawal rate. For example, assuming the investment amount of $1,000,000 and the desired withdrawal rate of 5%, the initial withdrawal amount for the beginning year is set to $50,000. At step 204, an asset class having the highest rate of return in the beginning year is determined. The initial withdrawal amount is withdrawn from the determined asset class. Consider for example the investment amount is invested in two asset classes, for example, in a bond account and an equity account and assume that the rate of return for the bond account is higher than the equity account. In that case, the initial withdrawal amount ($50,000 in the example) is withdrawn from the bond account.

At step 206, withdrawal amounts for subsequent years of the withdrawal period are calculated based at least in part upon the initial withdrawal amount for the beginning year. As explained earlier, the withdrawal amounts for the subsequent years may or may not be indexed to the initial withdrawal amount for the beginning year. Further, for each subsequent year, an asset class having the highest rate of return is determined and a corresponding withdrawal amount for the subsequent year is withdrawn from the determined asset class.

At step 208, present values of the plurality of asset classes at the beginning year are calculated. In an embodiment, a present value at the beginning year is calculated for an asset class, from which the initial withdrawal amount is made in the beginning year based upon yearly withdrawal amounts from the asset class during the withdrawal period and corresponding historical rates of return. Consider, for example, that investment is made in two asset classes, namely, an equity account and a bond account and that the initial withdrawal amount is withdrawn from the equity account, the present value of the equity account at the beginning year is calculated based upon yearly withdrawals from the bond account and corresponding historical rates of return. The present value for the bond account is then calculated by subtracting the present value of the equity account from the investment amount. Similarly, consider another example the investments are made in three asset classes, namely, a bond account, an equity account and an international fund account and that the initial withdrawal amount is withdrawn from the bond account in the beginning year. The present value of the bond account at the beginning year is calculated based upon yearly withdrawal amounts from the bond account within the withdrawal period and the historical rate of returns for the bond account. Similarly, the present value of the equity account at the beginning year is calculated based upon yearly withdrawal amounts from the equity account within the withdrawal period and the historical rate of returns for the equity account. Once the present values of the bond account and the equity account are determined, the present value of the international fund account at the beginning year is calculated by subtracting a sum of the present values of the bond account and the equity account from the investment amount. A similar methodology may be applied to calculate present values of different classes where the investment is made in more than three asset classes. The present values of the plurality of asset classes at the beginning year are used to determine an initial percentage distribution of assets across the plurality of asset classes.

At step 210, an asset-wise end balance is calculated for each asset class based upon the respective present value in the beginning year, the respective yearly withdrawal amounts, and the respective historical rates of return. The end balance for a given asset class is an amount remaining in the given asset class at the end of the withdrawal period. In addition, yearly starting balances and yearly remaining balances may also be calculated for each asset class based upon the yearly withdrawal amounts and the corresponding yearly historical rates of return. The yearly starting balances for the plurality of asset classes are used to determine yearly percentage distribution of assets into the plurality of asset classes. Further, a total end balance may be calculated by adding the asset-wise end balances for the plurality of asset classes.

At step 212, the initial withdrawal amount for the beginning year is adjusted based upon the asset-wise end balances and the desired end balance. In an embodiment, when the user enters zero as the desired end balance, if an end balance for any of the asset classes or the total end balance is less than zero, the initial withdrawal amount for the beginning year is decreased and if an end balance for any of the asset classes or the total end balance is more than zero (or zero plus a threshold), the initial withdrawal amount for the beginning year is increased. The threshold may be employed to increase convergence speed of the optimization described herein. The threshold may be entered by the user or may be set as a percentage of the investment amount. According to one embodiment, when the desired end balance is indicative of the bequest or the hedging, if the total end balance is less than the desired end balance (the desired balance minus the threshold), the initial withdrawal amount for the beginning year is decreased and if the total end balance is more than the desired end balance (or the desired balance plus the threshold), the initial withdrawal amount for the beginning year is increased.

Once the initial withdrawal amount for the beginning year is adjusted, steps 202 to 212 are repeated with the adjusted initial withdrawal amount for the beginning year until the asset-wise end balances satisfy the desired end balance. At this point, no adjustment is made to the initial withdrawal amount for the beginning year and the initial withdrawal amount for the beginning year is the optimal withdrawal amount for the beginning year. Thus, it will be appreciated that the calculation of the optimal withdrawal amount for the beginning year depends upon several factors such as the beginning year, the initial withdrawal amount for the beginning year, the historical rates of returns, the present values of the plurality of assets, the desired end balance, etc. and several iterations of the exemplary method 200 may be required to obtain the optimal withdrawal amounts for the withdrawal period.

In an embodiment, annuity-based withdrawals may also be incorporated when calculating the optimal withdrawal amounts of the financial product. In this case, a withdrawal amount in any given year is realized by first withdrawing an annuity component from an annuity account and withdrawing a remainder of the withdrawal amount from an asset class having the highest rate of return in any given year. The withdrawal amounts and the annuity amount can then be used to determine the optimal withdrawal amount and optimal asset distribution as described herein. The user may enter a desired annuity amount, annuity interest rate and annuity duration. The annuity duration may be the same as the withdrawal duration or may be different. In an embodiment, the annuity may be an annuity-certain.

FIG. 3(A) illustrates an exemplary user interface 302 for receiving withdrawal parameters associated with the financial product, in accordance with an embodiment of the present disclosure. A user may provide the withdrawal parameters via the user interface 302. In an example, the user interface 302 can be a spreadsheet accessible via a user device or a graphical user interface provided by an application and displayed on the user device. The user device may be, for example, a tablet, a smartphone, a laptop, etc. In another example, the user interface 302 may be a web-based interface accessible by a web browser installed in the user device. In the current example, the user enters a withdrawal period of 30 years, a beginning balance of $1,000,000, a beginning year of 2000 and a desired end balance of $0. The user may enter other parameters such as a gender, an age of the user, etc. via the user interface 302.

Further, according to the present example, the user selects the historical CPI-U values as the index parameters, the adjustment parameter for the equity account as −5 basis points and the adjustment parameter for the bond account as −8 basis points.

FIGS. 3(B)-3(C) illustrate exemplary user interfaces 304 and 306 displaying optimal withdrawal amounts to be withdrawn annually from two asset classes over the withdrawal period, in accordance with an embodiment of the present disclosure. In the present example, the two asset classes are the equity account and the bond account.

The system determines historical years to be considered for the withdrawal period based on the beginning year inputted by the user. The withdrawal period, in the example illustrated in FIG. 3(A), is 30 years. Further, in the present example, the historical rates of return for the equity account correspond to the S&P 500 equity index and the historical rates of return for the bond account corresponds to the Barclays aggregate bond index. The system obtains the historical rates of return from year 2000 up to year 2014, which, for example, is the year until which the historical rates of return are available. Then, the system obtains the rates of return from year 1985 up to year 1999 to complete the withdrawal period of 30 years.

The system selects a beginning withdrawal amount, for example, $50,000, for a first historical year 2000. The system may select the beginning withdrawal amount based on the beginning year, the withdrawal period, and/or a desired withdrawal rate, etc. The system compares the rates of return for the beginning year. In the current example, the rate of return for the bond account (11.55%) is greater than the rate of return for the equity account (−9.15%). Thus, the beginning withdrawal amount is withdrawn from the bond account. Similarly, for the year 2003, the rate of return for the equity account (27.74%) is greater than the rate of return for the bond account (4.03%). Hence, a withdrawal is made from the equity account in 2003. Thus, the system determines, for all years of the withdrawal period, an asset classes for withdrawal and the corresponding withdrawal amount. The system may calculate the end balance at the end of the withdrawal period, i.e. at the year 1999 in the current example and compare it with the desired balance. The system adjusts the beginning withdrawal amount based upon the comparison. The system keeps adjusting the beginning withdrawal amount until the desired balance of zero is met for the bond account and the equity account. The beginning amount at which such a condition is met is the optimal withdrawal amount for the beginning year. In the current example, the optimal withdrawal amount for the beginning year is calculated to be $50,642. Once the optimal withdrawal amount for the beginning year is calculated, the withdrawal amounts for the remaining years of the withdrawal period are calculated as illustrated.

The system calculates a present value of the bond account at the beginning year based upon the optimal withdrawal amount for the beginning year, withdrawal amounts from the bond account and the historical rates of return for the bond account. In the present example, the present value of the bond account at the year 200 is $252,616. The system subtracts the present value of the bond account at the year 2000 from the investment amount of $1,000,000 to obtain a present value of the equity account at the year 2000 as $747,384. Further, the system calculates the yearly starting balance and yearly remaining balance for all asset classes. The staring balance and the remaining balance for the bond account are denoted by the columns Fixed Balance and Remainder in FIG. 3(C), respectively. The same for the equity account are denoted by the columns Return Balance and Remainder in FIG. 3(C).

The present value of each asset class is divided by the investment amount to obtain an asset distribution at the beginning year. Hence, for the year 2000, the equity to bond ratio is 75:25. Similarly, the system calculates asset distribution for remaining years of the withdrawal period. The percentage assets in the equity account for the present example are illustrated in FIG. 3(D). As can be seen, in this example, unlike conventional asset allocation techniques, percentage of assets in the equity account increases over the withdrawal period, thereby resulting in higher returns for the user while at the same time achieving the desired end balance specified by the user. FIG. 3(D) illustrates an exemplary user interface 308 displaying an optimal distribution of asset classes, in accordance with an embodiment of the present disclosure.

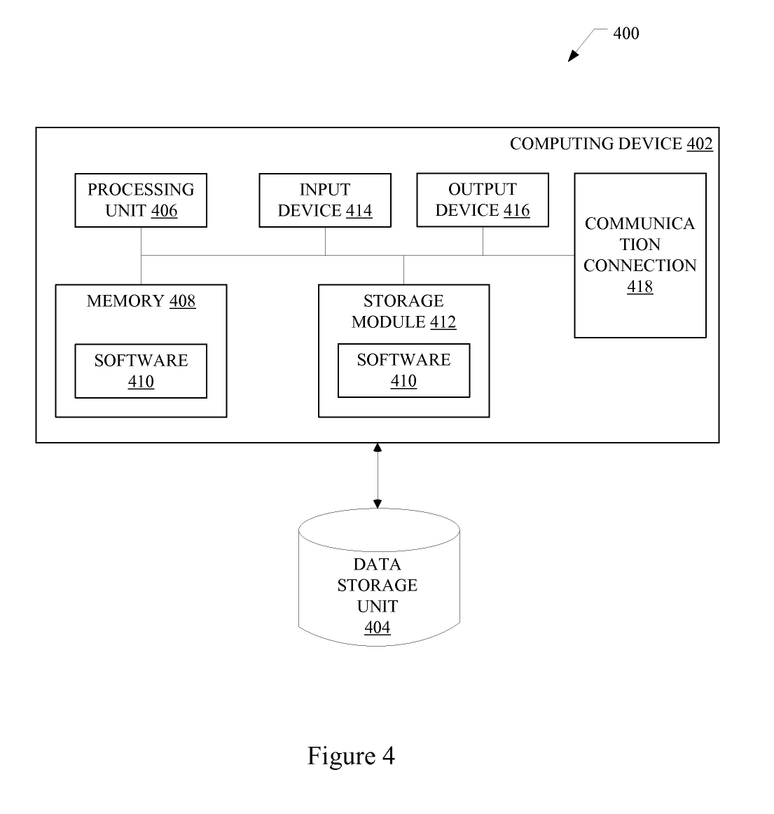

FIG. 4 illustrates an exemplary computing system 400 for determining optimum withdrawal amounts for a financial product, in accordance with an embodiment of the present disclosure. The computing system 400 comprises a computing device 402 and a data storage unit 404. The computing device 402 may be, for example, a personal computer, a laptop, a tablet, a smartphone, a server, etc.

The computing device 402 may include at least one processing unit 406 and a memory 408. The processing unit can execute computer-executable instructions and can be a real or a virtual processor. In a multi-processing system, multiple processing units can execute computer-executable instructions to increase processing power. The memory can be a volatile memory (e.g., registers, cache, RAM), a non-volatile memory (e.g., ROM, EEPROM, flash memory, etc.), or some combination of the two. In some embodiments, the memory may store instructions of software 410 implementing various functionalities of the disclosure described herein.

The computing device 402 may include additional features. For example, the computing device 402 may include storage modules 412, one or more input devices 414, one or more output devices 416, and one or more communication connections 418. An interconnection mechanism (not shown) such as a bus, a controller, or network components can interconnect the components of the computing device 402. Typically, operating system software can provide an operating environment for other software executing in the computing device 402, and can coordinate activities of the components of the computing device 402.

The storage modules 412 can be removable or non-removable, and may include magnetic disks, magnetic tapes or cassettes, CD-ROMs, CD-RWs, DVDs, USB drive, or any other medium which can be used to store information and which can be accessed by and within the computing device 402 unconstrained by geographic location. In some embodiments, the storage modules 412 may store instructions of the software 410 implementing various functionalities of the disclosure described herein.

The input device(s) 414 may be a touch input device such as a keyboard, mouse, pen, trackball, touch screen, or a game controller, a voice input device, a scanning device, a digital camera, or another device that provides input to the computing device 402. The output device(s) 416 may be a display, printer, speaker, or another device that provides output from the computing device 402.

The communication connection(s) 418 can enable communication over a communication medium to another computing entity. Examples of the communication media include, but are not limited to, wired or wireless techniques implemented with an electrical, optical, RF, infrared, acoustic, or other carrier.

In an embodiment, the computer system 400 may be implemented in a network environment, for example, as a cloud-based system accessible over a network, in accordance with an embodiment of the present disclosure. The historical rates of return are stored in a data storage unit 404. In an embodiment, the data storage unit 404 may be a database accessible by the computing device 402. The database may be, for example, a structured query language (SQL) database, a NoSQL database such as the Microsoft® SQL Server, the Oracle® servers, the MySQL® database, etc. The database may be located remotely from the computing device 402 and accessible over a network. In an embodiment, the data storage unit 404 may be any conventional memory accessible to the computing device 402 or residing within the computing device 402. The data storage unit 404 may store the historical rates of return data, present value of asset classes, etc.

In an embodiment, the computing system 400 may be deployed in a network-based environment, for example, in a cloud-based environment managed by a cloud storage service provider or as software-as-a-service (SaaS). In this case, the user can access various functionalities of the computing system 400 over a network. In another embodiment, the computing system 400 may be integrated in a single computing device such as the computing device 402. Further, in an embodiment, functionalities of the present disclosure may be implemented in the form of an application running on a computing device such as the computing device 402.

No one embodiment disclosed herein is essential to the practice of another unless indicated as such. Indeed, the invention, as supported by the disclosure above and in the originally filed claims, includes all systems and methods that can be practiced from all suitable combinations of the various aspects disclosed, and all suitable combinations of the exemplary elements listed. Such combinations have particular advantages, including advantages not specifically recited herein.

Alterations and permutations of the preferred embodiments and methods will become apparent to those skilled in the art upon a reading of the specification and a study of the drawings.

Accordingly, none of the disclosure of the preferred embodiments and methods defines or constrains the invention. Rather, the issued claims variously define the invention. Each variation of the invention is limited only by the recited limitations of its respective claim, and equivalents thereof, without limitation by other terms not present in the claim.

I claim:

1. A computer implemented method comprising:
obtaining, from a user via a user interface, withdrawal parameters associated with a financial product, the withdrawal parameters comprising a withdrawal period, an investment amount, a beginning year and a desired end balance;
obtaining, from a data storage unit, historical rates of return associated with a plurality of asset classes for the withdrawal period;
calculating, by a computing system, an optimal withdrawal amount for the beginning year based at least in part upon the withdrawal parameters and the historical rates of return, wherein the optimal withdrawal amount for the beginning year is withdrawn from an asset class from the plurality of asset classes having the highest rate of return in the beginning year; and
calculating, by the computing system, optimal withdrawal amounts for subsequent years of the withdrawal period based at least in part upon the optimal withdrawal amount for the beginning year, wherein the optimal withdrawal amount for each subsequent year is withdrawn from an asset class from the plurality of asset classes having the highest rate of return in said subsequent year.

2. The computer implemented method of claim 1, wherein the historical rates of return are obtained for historical years starting from the beginning year, and wherein when the historical rates of return data is unavailable for a portion of the withdrawal period, the historical rates of return are obtained for years prior to the beginning year until the historical rate of return data is available for the withdrawal period.

3. The computer implemented method of claim 1, wherein the calculating of the optimal withdrawal amount for the beginning year comprises:
selecting, by the computing system, an initial withdrawal amount for the beginning year;
calculating, by the computing system, withdrawal amounts for the subsequent years of withdrawal period based at least in part upon the initial withdrawal amount for the beginning year;
calculating, by the computing system, an end balance for each asset classes at the end of the withdrawal period; and
adjusting, by the computing system, the initial withdrawal amount for the beginning year based upon the end balance for each asset class and the desired end balance.

4. The computer implemented method of claim 1, wherein the plurality of asset classes comprises at least one of a bond fund, an equity fund, an international fund, and an exchange traded fund.

5. The computer implement method of claim 1, wherein the optimal withdrawal amounts for the subsequent years are indexed to the optimal withdrawal amount for the beginning year using an indexing parameter.

6. The computer implemented method of claim 1, further comprising calculating, for each asset class of the plurality of asset classes, a present value for each year of the withdrawal period based at least in part upon withdrawal amounts from the asset class during the withdrawal period and the historical rates of return for the asset class for the withdrawal period.

7. The computer implemented method of claim 6, further comprising calculating, for each year of the withdrawal period, an optimal asset allocation across the plurality of asset classes based upon the present values of the plurality of asset classes in the year.

8. The computer implemented method of claim 1, further comprising modifying the historical rates of return data for each asset class of the plurality of asset classes based upon a corresponding adjustment parameter for the asset class.

9. A computer program product comprising:
a non-transitory computer readable storage medium; and
a computer program code embedded in the non-transitory computer readable storage medium for causing a processor to:
obtain, from a user via a user interface, withdrawal parameters associated with a financial product, the withdrawal parameters comprising a withdrawal period, an investment amount, a beginning year and a desired end balance;
obtain, from a data storage unit, historical rates of return associated with a plurality of asset classes for the withdrawal period;
calculate an optimal withdrawal amount for the beginning year based at least in part upon the withdrawal parameters and the historical rates of return, wherein the optimal withdrawal amount for the beginning year is withdrawn from an asset class from the plurality of asset classes having the highest rate of return in the beginning year; and
calculate optimal withdrawal amounts for subsequent years of the withdrawal period based at least in part upon the optimal withdrawal amount for the beginning year, wherein the optimal withdrawal amount for each subsequent year is withdrawn from an asset class from the plurality of asset classes having the highest rate of return in said subsequent year.

10. The computer program product of claim 9, further comprising a computer program code embedded in the non-transitory computer readable storage medium for causing the processor to:
select an initial withdrawal amount for the beginning year;
calculate withdrawal amounts for the subsequent years of withdrawal period based at least in part upon the initial withdrawal amount for the beginning year;
calculate an end balance for each asset classes at the end of the withdrawal period; and
adjust the initial withdrawal amount for the beginning year based upon the end balance for each asset class and the desired end balance determine a distribution of assets into the plurality of asset classes for the first historical year of the historical years based upon an optimal withdrawal amount for the first historical year and a present value associated with each asset class.

11. The computer program product of claim 9, further comprising a computer program code embedded in the non-transitory computer readable storage medium for causing the processor to index the optimal withdrawal amounts for the subsequent years to the optimal withdrawal amount for the beginning year using an indexing parameter.

12. The computer program product of claim 9, further comprising a computer program code embedded in the non-transitory computer readable storage medium for causing the processor to calculate, for each asset class of the plurality of asset classes, a present value for each year of the withdrawal period based at least in part upon withdrawal amounts from the asset class during the withdrawal period and the historical rates of return for the asset class for the withdrawal period.

13. The computer program product of claim 9, further comprising a computer program code embedded in the non-transitory computer readable storage medium for causing the processor to modify the historical rates of return data for each asset class of the plurality of asset classes based upon a corresponding adjustment parameter for the asset class.

14. The computer program product of claim 9, wherein the plurality of asset classes comprises at least one of a bond fund, an equity fund, an international fund, and an exchange traded fund.

15. A system comprising:
a data storage unit to store historical rates of return for a plurality of asset classes; and
a processing unit, coupled to the data storage unit, configured to:
obtain, from a user via a user interface, withdrawal parameters associated with a financial product, the withdrawal parameters comprising a withdrawal period, an investment amount, a beginning year and a desired end balance;
obtain, from the data storage unit, the historical rates of return associated with the plurality of asset classes for the withdrawal period;
calculate an optimal withdrawal amount for the beginning year based at least in part upon the withdrawal parameters and the historical rates of return, wherein the optimal withdrawal amount for the beginning year is withdrawn from an asset class from the plurality of asset classes having the highest rate of return in the beginning year; and
calculate optimal withdrawal amounts for subsequent years of the withdrawal period based at least in part upon the optimal withdrawal amount for the beginning year, wherein the optimal withdrawal amount for each subsequent year is withdrawn from an asset class from the plurality of asset classes having the highest rate of return in said subsequent year.

16. The system of claim 15, wherein the processing unit is further configured to:
select an initial withdrawal amount for the beginning year;
calculate withdrawal amounts for the subsequent years of withdrawal period based at least in part upon the initial withdrawal amount for the beginning year;
calculate an end balance for each asset classes at the end of the withdrawal period; and
adjust the initial withdrawal amount for the beginning year based upon the end balance for each asset class and the desired end balance determine a distribution of assets into the plurality of asset classes for the first historical year of the historical years based upon an optimal withdrawal amount for the first historical year and a present value associated with each asset class.

17. The system of claim 15, wherein the processing unit is further configured to index the optimal withdrawal amounts for the subsequent years to the optimal withdrawal amount for the beginning year using an indexing parameter.

18. The system of claim 15, wherein the processing unit is further configured to calculate, for each asset class of the plurality of asset classes, a present value for each year of the withdrawal period based at least in part upon withdrawal amounts from the asset class during the withdrawal period and the historical rates of return for the asset class for the withdrawal period.

19. The system of claim 15, wherein the processing unit is further configured to modify the historical rates of return data for each asset class of the plurality of asset classes based upon a corresponding adjustment parameter for the asset class.

20. The system of claim 15, wherein the plurality of asset classes comprises at least one of a bond fund, an equity fund, an international fund, and an exchange traded fund.
